(19) United States
(12) Patent Application Publication
(10) Pub. No.: US 2011/0239859 A1
(43) Pub. Date: Oct. 6, 2011

(54) SEAL FOR A PISTON ROD

(75) Inventors: Eckhard KIRCHNER, Ginsheim (DE); Paul DONNELY, Hobartville (AU); Simon FITZGERALD, Warwick (GB); Lou VILLANUEVA, Douglas Park (AU)

(73) Assignee: GM GLOBAL TECHNOLOGY OPERATIONS LLC, Detroit, MI (US)

(21) Appl. No.: 13/043,224

(22) Filed: Mar. 8, 2011

(30) Foreign Application Priority Data
Mar. 9, 2010 (GB) 1003860.2

(51) Int. Cl. F16J 1/00

(52) U.S. Cl. 92/172

(57) ABSTRACT

A piston arrangement includes, but is not limited to a hydraulically-actuated piston to move a piston rod within a cylinder to pivot a clutch actuating lever, the end of the cylinder being sealed by a boot-type seal having a central hole, though which the rod slides in a reciprocating manner. The seal is flexible to permit transverse movements of the piston rod and has a peripheral flange by means of which it is attached to the cylinder end.

### CROSS-REFERENCE TO RELATED APPLICATION

This application claims priority to British Patent Application No. 1003860.2, filed Mar. 9, 2010, which is incorporated herein by reference in its entirety.

### TECHNICAL FIELD

The technical field relates to a seal for a piston rod and in particular a sealing arrangement for the combination of an actuating lever and piston in a hydraulic clutch system for automotive applications.

### BACKGROUND

In actuating piston arrangements a seal is required around the piston itself within an actuator cylinder. In automotive and other applications a seal is also required where the piston rod or actuator rod leaves the cylinder; this it to prevent dust and dirt from entering the cylinder.

One arrangement for sealing the end of a cylinder is used in the DQ200 transmission system produced by Volkswagen. Here a bellows-type dust cover is fixed to the end of the actuator cylinder and to the end of the piston rod. The bellows expand and contract as the piston rod slides in a reciprocating manner in the cylinder. The end of the piston rod is connected via a ball joint to the end of an actuating lever, or apply lever, of a hydraulic clutch mechanism. Any resistance in the ball joint is transferred as a load to the piston; any side load applied to the piston creates drag which leads to wear of the piston seal. The bellows-type cover is a relatively-expensive component and it is a relatively complicated and time-consuming procedure to attach it to the piston arrangement.

It is desirable to overcome or at least reduce one or more of the aforementioned problems. In addition, other objects, desirable features and characteristics will become apparent from the subsequent summary and detailed description, and the appended claims, taken in conjunction with the accompanying drawings and this background.

### SUMMARY

A piston arrangement is provided that comprises a piston that is capable of reciprocating movement in a cylinder and which is attached to one end of a piston rod, the other end of the piston rod extending out of an end of the cylinder and being rotatably attached to a pivotal actuating lever, a seal member being provided between the piston rod and the end of cylinder characterised in that the seal member has a hole the edges of which sealingly engage the piston rod and through which the piston rod is arranged to slide in a reciprocating manner.

At least one advantage of using such a sliding seal member is that there is a reduction in unwanted mechanical loads being transferred from the actuating lever via the piston rod to the piston. In addition, the sliding seal member has the advantages of being low-cost, and of being quick to install and replace while still providing good protection against the ingress of dust and dirt. Preferably, the attachment of the piston rod with the actuating lever is such that there is no contact between the actuating lever and the seal member. The advantage of this is that no resistance or drag effect is produced by the seal member on the attachment.

In an embodiment, the seal member, at least in regions adjacent the hole is flexible to allow movements of the piston rod transverse to its direction of sliding. By freely permitting such movements, the seal member removes mechanical loads from the arrangement.

### BRIEF DESCRIPTION OF THE DRAWINGS

The present invention will hereinafter be described in conjunction with the following drawing figures, wherein like numerals denote like elements, and

FIG. 1 shows a prior art piston arrangement in a first disposition in that it causes a clutch to be engaged;

FIG. 2 shows the piston arrangement of FIG. 1 in a second disposition in which it causes the clutch to be disengaged;

FIG. 3 shows a piston arrangement in accordance with a first embodiment in a first disposition in which it causes a clutch to be engaged;

FIG. 4 shows the piston arrangement of FIG. 3 in a second disposition in which it causes the clutch to be disengaged;

FIG. 5 is an enlarged view of a seal member of the arrangement of FIG. 3 and FIG. 4;

FIG. 6 is a similar view to FIG. 5 of a modified seal member for use in the arrangement of FIG. 3 and FIG. 4; and

FIG. 7 shows part of a piston arrangement in accordance with a second embodiment.

### DETAILED DESCRIPTION

The following detailed description is merely exemplary in nature and is not intended to limit application and uses. Furthermore, there is no intention to be bound by any theory presented in the preceding background or summary or the following detailed description.

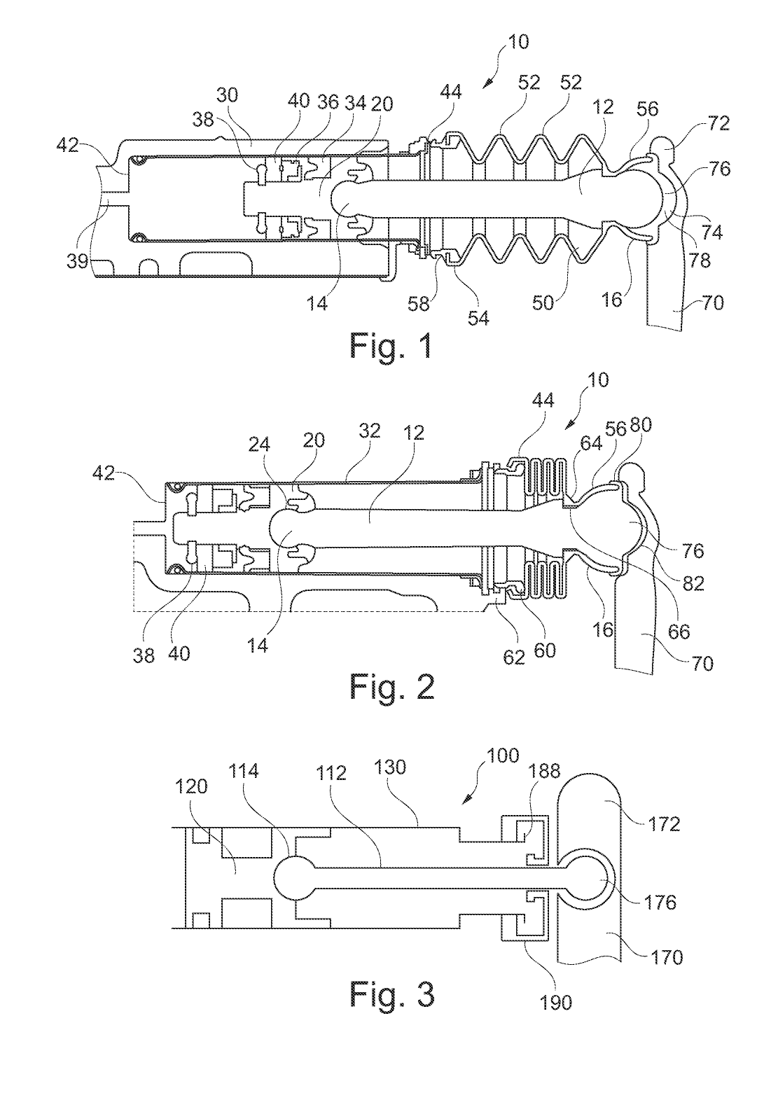

Referring to the drawings, FIG. 1 and FIG. 2 show a prior art piston arrangement 10. A piston rod or pin 12 attached to an actuator piston 20 is arranged to move in a reciprocating manner in a cylinder housing 30. The rod 12 is provided with respective ball joints 14, 16 at its opposite ends.

Ball joint 14 is located within a corresponding ball socket 24 of the piston 20 and is capable of a limited amount of rotation relative thereto. The piston is sealed relative to the interior wall 32 of cylinder 30 by means of a sliding seal 34. Also associated with the piston 20 is a magnet 36, which can be sensed by a detector (not shown) to indicate the position of the piston, and thus whether or not the associated clutch is engaged. The seal 34 and magnet 36 are held on the piston by a retaining ring 38 applied against a guiding ring 40.

The piston is urged to the right in FIG. 1 by hydraulic pressure though the introduction of hydraulic fluid via inlet 39 to the cylinder 30 at an otherwise closed first end 42 thereof. The other cylinder end 44, through which rod 12 passes, is substantially open and is in communication with the interior of a bellows-type dust cover 50. The cover comprises a plurality of corrugations 52 extending between a first cover end 54 and a second cover end 56. At end 54, a circular lip 58 of the cover engages with a first connector element 60, which is arranged to snap-fit with a second connector element 62 fixedly attached to the end 44 of the cylinder. Adjacent end 56, a reduced collar portion 64 of the cover engages with a groove 66 of the rod 12.

At its right-hand end in FIG. 1, rod 12 is arranged to pivot an articulated lever 70. The upper end 72 of the lever is formed with a shaped recess 74. To allow rotation of ball joint 16 and to produce a sealing effect, the recess 74 in the lever end 72 is provided with an insert 76. Insert 76 is generally part-spherical and has a radially inner face in the form of a ball socket 78 to receive ball joint 16, a radially outer face which fits in recess 74, and a connector 80 which snap fits to the end 56 of cover 50. Thus it will be seen that a sealed enclosure for the rod 12 is provided by a combination of the piston 20 itself, cylinder 30, cover 50 and insert 76.

Lever 70 actuates a clutch (not shown) of a hydraulic clutch assembly (not shown). It is pivotally-mounted at its other end and is resiliently-biased to the left in FIG. 1, so that when the hydraulic pressure is removed from inlet 39, the rod 12 is urged into the position shown in FIG. 2. This is accompanied by collapsing of the bellows cover 50. It is also accompanied by some undesired movement of the lever end 72 and thus rod 12 as will now be described.

Since the lever 70 rotates about a fulcrum (not shown) at some distance from the longitudinal axis of rod 12, the movement of lever end 72 between the positions shown in FIGS. 1 and 2 is slightly curved. Although this can be partially compensated by rotation of the ball joints 14, 16 in their respective sockets, the piston arrangement still needs to provide further accommodation to take into account the lateral displacements of lever end 72, i.e. any movements of the lever end transverse of the longitudinal axis of rod 12. It will be appreciated that the major component of this movement will be up and down in FIG. 1 and FIG. 2, i.e., in the plane of the paper. As seen in FIG. 2, some of the relative movement is accommodated by a small shift between the lever end 72 and the insert 76, see the gap 82 which opens up. Some of the relative movement could be taken up by movement of insert 76 itself, but as this is resisted by its engagement with cover end 56, this component is transferred as a load along the rod 12 to piston 20 at least some of this load appears as a side load on the piston 20 and in particular on to seal 34, which is thus liable to wear over a period of use.

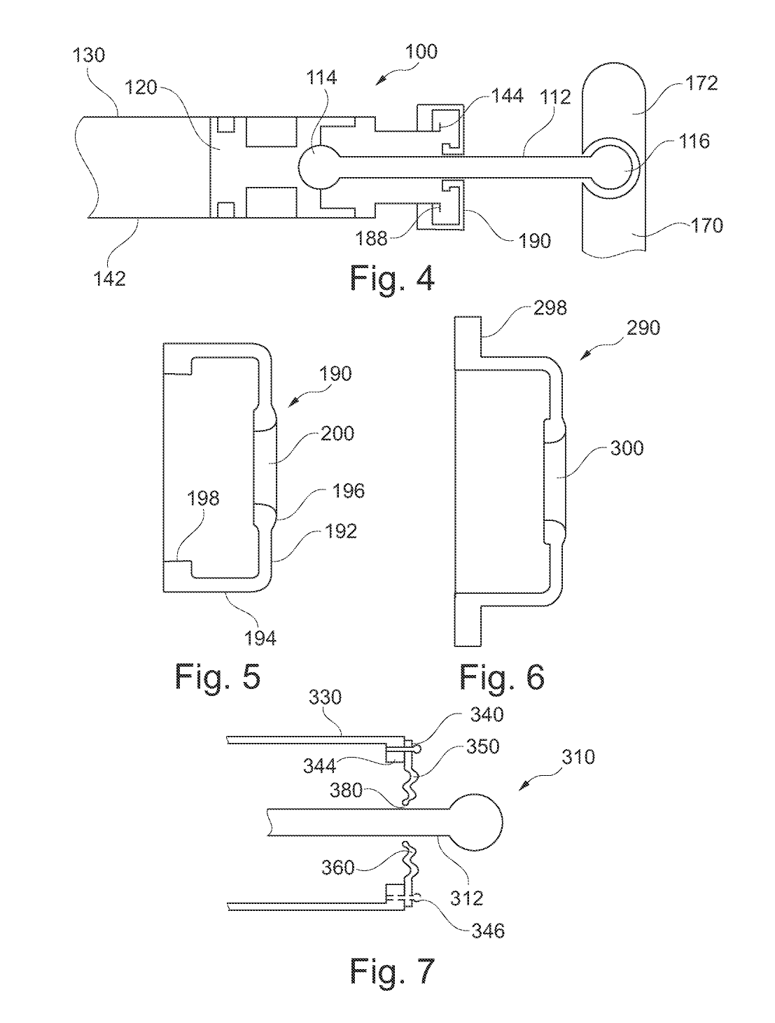

Referring now to FIG. 3 and FIG. 4, there are shown simplified views of a piston arrangement 100 in accordance with a first embodiment. To the extent that features are omitted, they are preferably the same as the arrangement of FIG. 1 and FIG. 2. However, functionally equivalent features may be employed. In similar fashion to the arrangement of FIG. 1 and FIG. 2, the piston arrangement 100 comprises a piston rod 112, having end ball joints 114, 116, with ball joint 114 engaging a hydraulically-actuated piston 120 and with ball joint 116 engaging the end 172 of a pivotal lever 170 which actuates a clutch mechanism. The arrangement comprises a cylinder 130 having ends 142 and 144. Right hand end 144 is provided with a flange or shoulder 188.

Instead of a bellows-type cover, end 144 is provided with a rubber boot type dust seal member 190. An enlarged view of seal member 190 is shown in FIG. 5. Before installation, as shown in FIG. 5, the seal member is substantially cup-shaped having a base 192 and a cylindrical wall portion 194. Base 192 has a central hole 200 which is of a size to engage the piston rod 112 in sealing manner, but to allow the rod to slide there through. The periphery of hole 194 is provided with a reinforcement seal or lip 196. The top of the cup shape is provided with a radially inwardly directed flange or lip 198. As shown in FIG. 3 and FIG. 4, flange 198 is placed over and behind cylinder flange 188 to axially retain the sealing member 190 and to secure it in place.

The thickness and flexibility of the material of the seal member 190 are selected so that it provides support for the rod 112 yet permits both reciprocating sliding movements of the rod and lateral movements of the rod. As shown, the region around hole 200 is distorted when the seal member is installed to hold the rod 112.

The rod 112 moves in a similar manner to rod 12 between the positions shown in FIG. 3 and FIG. 4, but seal member 190 remains substantially stationary. Because the ball joint 116 is spaced from the lever end 172 at all times, there is no interference between these two members and in particular no resistance to, or drag effects on, the free rotation of the ball joint. Furthermore, the flexibility of the seal member 190 permits relatively-free transverse movements of the rod, i.e., principally up-and-down movements in FIGS. 3 and 4, as the lever 170 pivots. Because this end of the rod 112 is freely moveable, no loads (or only minimal loads) are transferred along the rod to the cylinder 130. Thus wear of the piston seals is avoided (or substantially reduced). Furthermore, the reduction of drag increases the control capability if the arrangement.

An advantage of the seal member 190 is that it is relatively cheap, while the engagement of the edges of hole 200 with the piston rod 112 provides an adequate seal to protect ball joint 114 and cylinder 130 from the contaminating effects of the ingress of dust and dirt. The seal member also lasts longer than other types of seal.

Various modifications may be made to the arrangement 100 described in connection with FIG. 3 and FIG. 4. As mentioned previously, some or all of the features of the arrangements 10 of FIGS. 1 and 2 may be incorporated. Depending on the pivoting mechanism for lever 170 and the disposition of the actuated clutch mechanism, the positions of FIG. 3 and FIG. 4 may be interchanged so that FIG. 4 shows the engaged position and FIG. 3 the disengaged position.

Two arrangements 100 are typically provided side-by-side in the transmission system of a vehicle, one operating a clutch mechanism for the odd-numbered gears, and the other operating a clutch mechanism for the even-numbered gears. The arrangement is particularly suitable for a dry dual clutch transmission although it can be used with other mechanisms and can be operated other than hydraulically.

Ball joint 116 and/or ball joint 114 may be replaced by a roller bearing or by any other suitable pivotal arrangement with a suitable pivot axis (i.e., directed out of the plane of the paper in FIG. 3 and FIG. 4). The seal member 190 can be made from any suitable elastomeric or flexible material. The seal member may be shaped differently. For example, it may be substantially planar in the form of a circular disc. In this case flange 198 is substantially L-shaped so as to engage behind flange 188.

Alternatively the seal member 190 may be replaced by the seal member or cover 290 of FIG. 6. In this modification, radially-inward flange 198 is replaced by a radially-outwardly directed flange 298. Flange 298 is secured to cylinder 130 by means of an annular retention plate (not shown) which can be attached to the cylinder end 144. The seal member 290 provides the same advantages as sealing member 190, particularly regarding simple installment and, if necessary, replacement. In addition, the different location of the flange 298 permits substantially more movement of the region of the seal member 290 around hole 300. Thus even lower loads are imposed thereby on the piston rod.

The flange 298 may be held by arrangements other than an annular retention plate. For example, an annular groove may be provided in cylinder end 144 and the seal member 290 can be gently pinched to snap-fit it into place in the groove.

FIG. 7 shows a seal member in the form of a dust cover 350 of a piston arrangement 310 in accordance with a second embodiment of the present invention. A piston rod 312 slides axially within a cylinder 330 and through a central hole 380 in the dust cover 350. In this embodiment, cover 350 is substantially planar with one or more substantially circular corrugations 360 surrounding the hole 380. The cover is made of a resilient material. A radially-extending lip 340 around the circumference of dust cover is secured to an end flange 344 of the cylinder 330 by a plurality of bolt members 346.

An advantage of this second embodiment is that the dust cover 350 is more securely attached to the cylinder 330 against inadvertent removal. An improved sealing effect is also provided here. Moreover, the corrugating 360 function similarly to a bellows-type arrangement and permit relatively-free transverse movements of piston rod 312. Other means may be used to fixedly interconnect lip 340 and flange 344, e.g. rivets or an adhesive. Flange 344 may extend radially outwardly instead of inwardly.

The features and modifications of the two described embodiments may be combined or interchanged or desired. For example, a substantially flat dust cover can be used in the first embodiment or a fixed attachment of the cover to the cylinder. Alternatively, in the second embodiment, a snap-fit, or any of the other arrangements mentioned in relation to the first embodiment, may be used to connect the cover and the cylinder. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A piston arrangement, comprising:
a cylinder with a first end;
a piston rod with a second end and third end;
a pivotal actuating lever;
a piston that is capable of a reciprocating movement in the cylinder and attached to the second end of the piston rod, the third end of the piston rod extending out of the first end of the cylinder and rotatably attached to the pivotal actuating lever; and
a seal member between the piston rod and the first end of the cylinder, the seal member having a hole with an edges sealingly engaging the piston rod and through which the piston rod is arranged for the reciprocating movement.

2. The piston arrangement according to claim 1, wherein attachment of the piston rod with the pivotal actuating lever is such that there is no contact between the pivotal actuating lever and the seal member.

3. The piston arrangement according to claim 1, wherein the seal member in at least regions adjacent the hole is flexible to allow movements of the piston rod transverse to a direction of sliding.

4. The piston arrangement according to claim 1, wherein the seal member is substantially stationary in an axial direction.

5. The piston arrangement according to claim 1, wherein the seal member comprises an elastomeric material.

6. The piston arrangement according to claim 1, wherein the seal member is substantially cup-shaped.

7. The piston arrangement according to claim 5, wherein the seal member and the cylinder have a snap-fit connection.

8. The piston arrangement according to claim 1, wherein the first end of the cylinder has a peripheral flange and the seal member has a radially-inwardly directed peripheral flange arranged to engage the peripheral flange on the cylinder.

9. The piston arrangement according to claim 1, further comprising a retaining member at the first end of the cylinder, and the seal member has a radially-outwardly directed peripheral flange arranged to engage the retaining member.

10. The piston arrangement according to claim 1, further comprising an annular groove at the first end of the cylinder, and the seal member has a radially-outwardly directed peripheral lip arranged to engage with the annular groove.

11. The piston arrangement according to claim 1, wherein the seal member is substantially planar.

12. The piston arrangement according to claim 11, wherein the seal member comprises a corrugation surrounding the hole.

13. The piston arrangement according to claim 11, wherein a periphery of the seal member is fixedly attached to the cylinder.

14. The piston arrangement according to claim 13, wherein the cylinder comprises a radially extending flange to which the periphery of the seal member is fixedly attached.
